(19) United States
(12) Patent Application Publication
(10) Pub. No.: US 2005/0023112 A1
(43) Pub. Date: Feb. 3, 2005

(54) Track system for tow-line conveyors

(76) Inventors: Robert B. Karnes, Hanover, MA (US); Richard C. Somerville, Duxbury, MA (US); Brian C. Evans, Marshfield, MA (US)

Correspondence Address: JENKENS & GILCHRIST, P.C., 225 WEST WASHINGTON, SUITE 2600, CHICAGO, IL, 60606, US

(21) Appl. No.: 10/631,044

(22) Filed: Jul. 29, 2003

(51) Int. Cl. B65G 15/60

(52) U.S. Cl. 198/838

(57) ABSTRACT

A towline conveyor including both straight and curved sections employs self-lubricating non-metallic wearing blocks against which a metallic chain moves. The wearing blocks are made of a polymer matrix having additives to increase resistance to wear and abrasion, providing extended life relative to metal rollers. Preferably, the wearing blocks are molded replaceable inserts for carrier blocks mounted on the track of the conveyor.

### FIELD OF THE INVENTION

This invention relates generally to chain-driven conveyors, and more particularly to tow-line conveyors, which move heavy articles along a track. Such conveyors may be installed overhead in a building to carry articles attached to or suspended from the chains. Alternatively, such conveyors may be installed in the floor of a building to pull wheeled containers along the floor.

### BACKGROUND OF THE INVENTION

The present invention solves a serious problem with a tow-line conveyor system that carried heavy loads and which was plagued by frequent repairs made necessary by the short life of metal rollers used to support and guide the chain through turns in the system. The previous conveyor system will be described in more detail below. It was lubricated with grease and it was found that wear was aggravated by the presence of metal particles, grit, and the other contaminants which became mixed with the grease, creating an abrasive mixture and accelerating the wear on the metal parts, particularly the metal rollers, requiring frequent replacement. If the metal rollers could be replaced with non-metallic parts successfully, then it was hoped that less maintenance of the conveyor system would be needed. The load placed on the non-metallic parts would be very high and it was not certain that non-metallic parts could be used. However, the present inventors found that by proper design of the non-metallic replacement parts and by appropriate formulation of the non-metallic materials, the life of the conveyor system could be greatly extended. Their solution will be described in detail below.

Among the many patents that describe conveyor systems are some in which plastic materials are employed. Examples of these include U.S. Pat. No. 6,450,326; U.S. Pat. No. 4,562,921; and U.S. Pat. No. 3,581,877.

U.S. Pat. No. 6,450,326 describes a chain-drive conveyor in which the load link assembly may be made of non-metallic, low friction, self-lubricating materials. The base material is said to be any one of many thermosets or thermoplastics. Additives include molybdenum disulfide, super-hard carbides, nitrides, and oxides of various metals including titanium among others. Several fibrous materials are suggested, including polyaramide fibers and other resins such as polyimides.

U.S. Pat. No. 4,562,921 suggests the use of ultra high molecular weight polyethylene as a self-lubricating material in guide rails in a conveyor system.

U.S. Pat. No. 3,581,877 similarly suggests the use of thermoplastic bumpers in conveyors that carry cans or bottles, to avoid marring of the containers.

Self-lubricating polymers have been suggested for applications where conventional lubrication with grease or oil is unsatisfactory or undesirable. These self-lubricating materials may include various ingredients which are compounded with the base polymer or polymers to provide the desired properties. Often, known lubricating solids such as molybdenum disulfide, graphite and the like are included. Polymers such as polytetrafluoroethylene, polyaramides, and polyolefins have also been suggested as additives which could reduce friction. Particles for containing liquid lubricants have been proposed as useful ingredients, for example silica or glass spheres and metal carbides or nitrides. The following patents are representative of the art.

U.S. Pat. No. 4,011,189 discloses using a siloxane dispersing agent to combine lubricants with incompatible polymers. U.S. Pat. No. 4,432,883 suggests including titanium carbide grains in various metal matrices, which are combined with polymers. U.S. Pat. No. 4,623,472 teaches adding lubricating oils to polyurethanes and suggests the addition of molybdenum disulfide. U.S. Pat. No. 4,945,216 suggests adding to polyolefins and polyurethanes molybdenum disulfide, graphite, and polytetrafluoroethylene as additives. U.S. Pat. No. 5,750,620 discloses using two polymers as the base material, to which are added an elastomer and other additives. U.S. Pat. No. 5,866,647 proposes adding glass beads to thermoplastics, e.g. nylons, and includes polyaramide fibers. U.S. Pat. No. 6,323,159 describes a polyurethane to which is added a fluid organic amide, which would be exuded from the polyurethane while in service. U.S. Pat. No. 6,569,186 describes a polyurethane which includes porous silica particles and various types of oils.

### SUMMARY OF THE INVENTION

A towline conveyor in accordance with the invention comprises a generally fixed track and a polymer-based wearing surface in the track. A chain is positioned to run in the track along the wearing surface. The wearing surface can be formed from a plurality of bearing sections which may comprise two or more compositions.

One embodiment of a conveyor comprises a mounting structure and a plurality of polymer-based wearing sections replaceably mounted in the mounting structure. The chain runs along the bearing surfaces.

Another embodiment is directed toward a replaceable bearing for a towline conveyor. The replaceable bearing comprises a polymer-based wearing surface and structure to removably connect the bearing to mounting structure. The mounting structure may, for example, be a carrier block mountable to current towline tracks or a steel structure cast into a floor.

In another aspect, the invention is the self-lubricating non-metallic composition surface of the wearing blocks. The composition comprises at least one matrix polymer, either thermoset or thermoplastic. In the case of the thermosets, the matrix polymer is preferably selected from the group including, but not limited to, amine-cured polyether urethane prepolymers, epoxies and vinyl esters. In the case of the thermoplastics, the matrix polymer is preferably selected from the group including, but not limited to, polyamides (nylons), acetals, and thermoplastic polyesters. In either case, other materials of appropriate properties are also candidates. The composition also comprises additives selected from the group including, but not limited to, molybdenum disulfide powder, titanium carbide particles, fluorinated ultrahigh molecular weight polyethylene, fluorinated polyether oil, powdered polytetrafluoroethylene, and polyaramide fibers. A preferred matrix polymer is an amine-cured polyether urethane prepolymer. In a preferred embodiment, each of the above listed additives is included.

In particularly preferred compositions, the polymer matrix will be about 60 wt % of the composition, the molybdenum disulfide will be about 12 wt %, the titanium carbide will be about 20 wt %, the fluorinated ultrahigh molecular weight polyethylene will be about 4 wt %, the fluorinated polyether oil will be about 2 wt %, the polytetrafluoroethylene will be about 1 wt %, and the polyaramide fibers will be about 1 wt %.

### BRIEF DESCRIPTION OF THE DRAWINGS

FIG. 1 illustrates a perspective view of a corner section of a prior art towline conveyor.

FIG. 2 illustrates a perspective view of a straight section of a prior art towline conveyor.

FIG. 3 illustrates a perspective view of a corner section of a towline conveyor in accordance with an embodiment of the invention.

FIG. 4 illustrates a perspective view of bearing block mountable in the corner section illustrated in FIG. 3.

FIG. 5 illustrates a perspective view of a carrier block of the bearing block illustrated in FIG. 4.

FIG. 6 illustrates a perspective view of a bearing insert illustrated in FIG. 4.

FIG. 7 illustrates a perspective view of a straight section of a towline conveyor in accordance with an embodiment of the invention.

### DESCRIPTION OF THE PREFERRED EMBODIMENTS

Towline Conveyors

Towline conveyors provide a flexible and efficient means of moving material over long routes through single or multiple facility levels, without the accidents and traffic congestion that occur with use of lift trucks. Towlines can be provided with advanced computer control systems that include optical, magnetic or mechanical controller technology, but the basic towline mechanical design has remained the same for many years.

There are numerous applications in which towline conveyor systems are used, either in warehouses (for example, tire distribution centers) or in mail and/or package sorting centers and assembly line manufacturing. Generally, towline conveyor systems are mounted in the floor, and carts or carrying units are pulled along by a chain, although sometimes the towline is overhead. In some applications, the carts have a dry weight of approximately 400 pounds and carry approximately 400 pounds of cargo. A typical towline may pull, for example, 40 such carts. In another application, the towline may pull 300 carts having a dry weight of approximately 100 pounds. In some applications, the cargo, for example an automobile fender, is attached directly to the chain (also referred to as a towline) of the conveyor. Typically towline systems automatically pull the units over fixed paths at a constant speed.

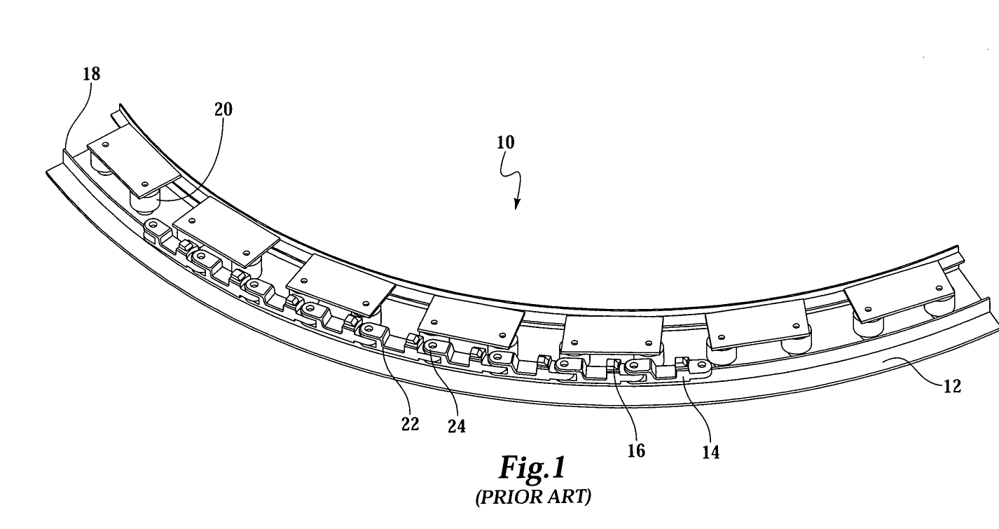

FIG. 1 illustrates a prior art towline corner section 10. The conveyor consists of chain tracks 12 installed in new or existing floors in which a chain 14 runs. The chain 14 comprises chain dogs 16 that engage towpins of each unit (which may for example be a cart or a part). The chain 14 is driven by one of several sprocket gears (not shown), and the motive force is transported by the chain around corners. A typical radius of curvature of corners in cart pulling applications is sixty inches. The chain 14 runs along a welded steel wear surface 18 against rollers 20 positioned on the inner radius of curvature of the track 12.

Existing towline designs substantially comprise solely grease-lubricated steel. This use of grease is a problem because dust becomes entrained in the grease and is trapped. The grease is added via grease fittings on the numerous rollers 20; the grease is expelled from the bearings of the rollers 20 and becomes part of the pool of grease on which the chain 14 slides. The rollers 20 control sideways motion of the towline while the towline chain 14 slides on the lower wear surface 18. Some dust is highly abrasive; the dirt and grit contamination greatly increases the wear rate of conventional grease-lubricated towlines. The only way to adequately clean such a system involves cleaning out all the grease, as by power washing or with solvent, followed by complete replacement of the grease. This type of cleaning and replacement is rarely done in practice; rather removal of grease from traps, and putting fresh grease in through the roller bearings, is all the cleaning that occurs on most towlines. Vacuuming or blowing the tracks out is ineffective because the loose dust that is not already caught gets caught in the grease when the dust is blown.

In addition to wear from contaminated grease, forces transmitted by the chain 14 causes substantial wear on the rollers 20. There is a substantial force on individual rollers 20 at corner sections and where a towed cart exerts sideways force on the towline (for example, during loading the cart or going around a corner). Since the rollers are substantially smaller (approximately 3 inches in diameter) than the steel chain-links 22 (approximately 6 inches in length) of the towlines, uneven forces are exerted on individual rollers 20 as a chain link 22 is pulled past the roller 20, from one link 22, through a knuckle 24 of the chain 14, then on to the next chain link 22. The chordal action of the chain 14 causes rollers 20 to see an oscillating load. Different chain designs can alter the location of maximum force; if the knuckle 24 is no wider than the rest of the chain, the maximum force should occur rear the middle of each chain link. The rollers 20 are, however, susceptible to breakdown.

Usually the rollers 20 at the corner section 10 of the towline are the first to fail. The high normal force exerted by the chain 14 increases the wear rate on the corner rollers 20 substantially compared to rollers that are along straight sections of towline. When these corner rollers 20 or their internal bearings wear to a critical extent, the roller 20 also can fail by destruction of the bearings or by buckling. The corner rollers 20 buckle when the diameter of the roller 20 becomes too small due to wear of the outer wall, and therefore the hollow rollers become too weak to resist their normal design loads. This failure forces a shutdown of the line for repair.

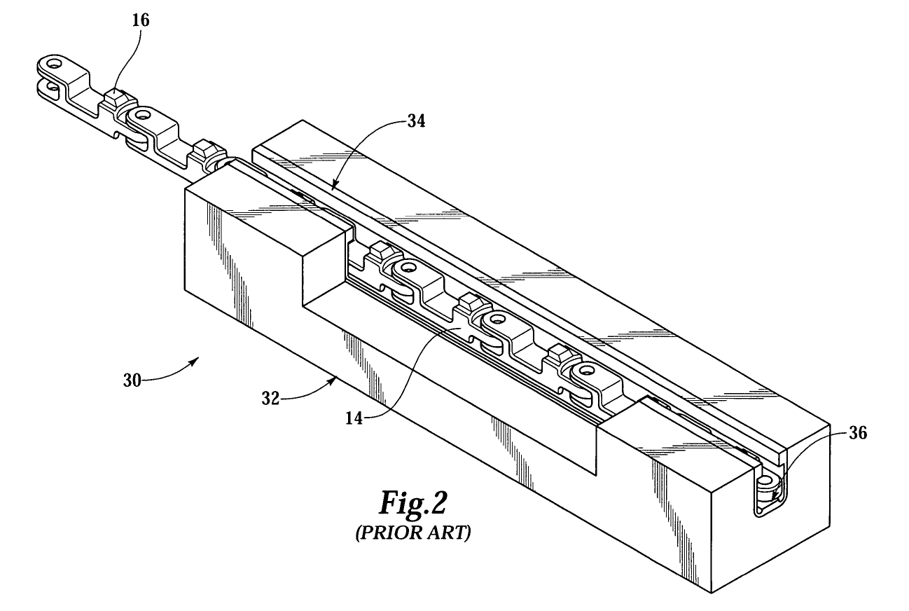

FIG. 2 illustrates a straight section 30 of a prior art conveyor mounted in a concrete floor 32. Part of the floor 32 is cut away to illustrate the chain 14 running along a steel guide 34 that is cast in concrete as part of the floor 32. To service the straight section 30, the floor must be chipped up, a new section of the steel guide welded into place, and the floor re-cast. Repair is thus a costly and time-consuming operation. The steel guide 34 comprises an integral steel wear surface 36 which is non-replaceable and only about 0.19 inches thick. When the steel wear surface 36 is worn down by the weight and abrasion of the steel chain 14, the conveyor must be serviced as described.

Another problem with prior art towline tracks is that they often squeal unpleasantly during operation, once the grease becomes contaminated, or bearings become worn. When prior art towline tracks become worn, the entire track section must be replaced, since there is no provision for replacing only the worn sections of the track (other than the rollers, which are replaceable).

The present invention overcomes these and other problems with prior art towline conveyors and chains.

Replacement of the Guide Rollers With Bearing Blocks

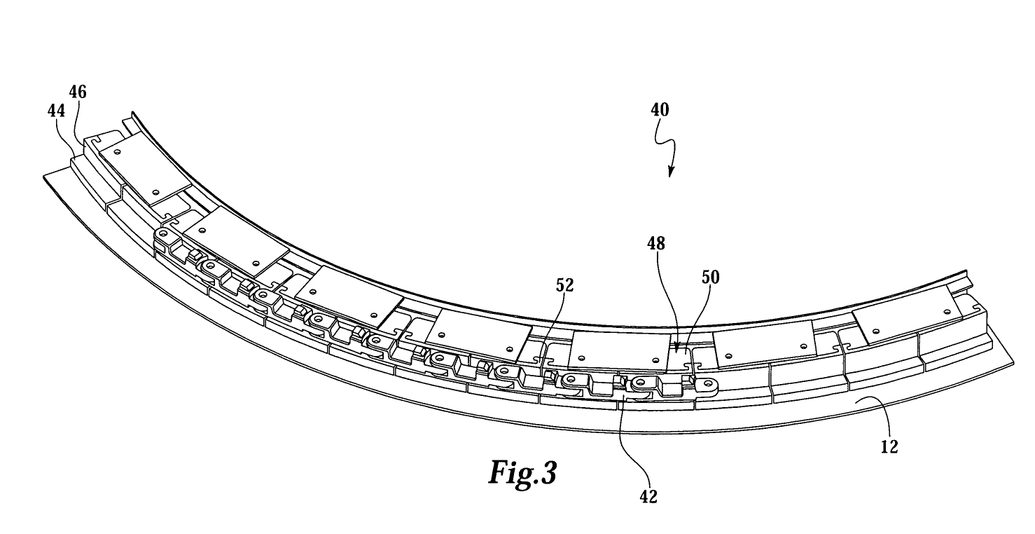

FIG. 3 illustrates a perspective view of a corner section 40 of a towline track system in which the towline, a metal chain 42 in prior art systems, slides along low-friction polymer-based wear surfaces 44 and 46 rather than against lubricated metal 18 and rollers 20 shown in FIG. 1. The abrasion resistance of different track components can be readily adjusted according to the specific demands of a given track section, as will be discussed below. For example, polymer formulations with superior abrasion resistance can be deployed in areas where abrasion is most severe, such as the inner radius of corners, while less expensive formulations can be used in straight track sections. Another feature of the invention is that portions of the track system 40 that touch the moving towline 42 are readily replaceable.

Referring to FIGS. 3-6, the towline corner section 40 comprises a plurality of bearing blocks 48 comprising carrier blocks 50 mated to bearing inserts 52; the bearing inserts 52 comprising the replaceable wear surfaces 44 and 46. The insert pieces 52 slide into the carrier block 50.

FIG. 4 illustrates a perspective view of the bearing block 48. The carrier block 50 is provided with through holes 54 and 56 to bolt into existing floor structure 12 of prior art systems. The inserts 52 are held in place by set screws (not shown).

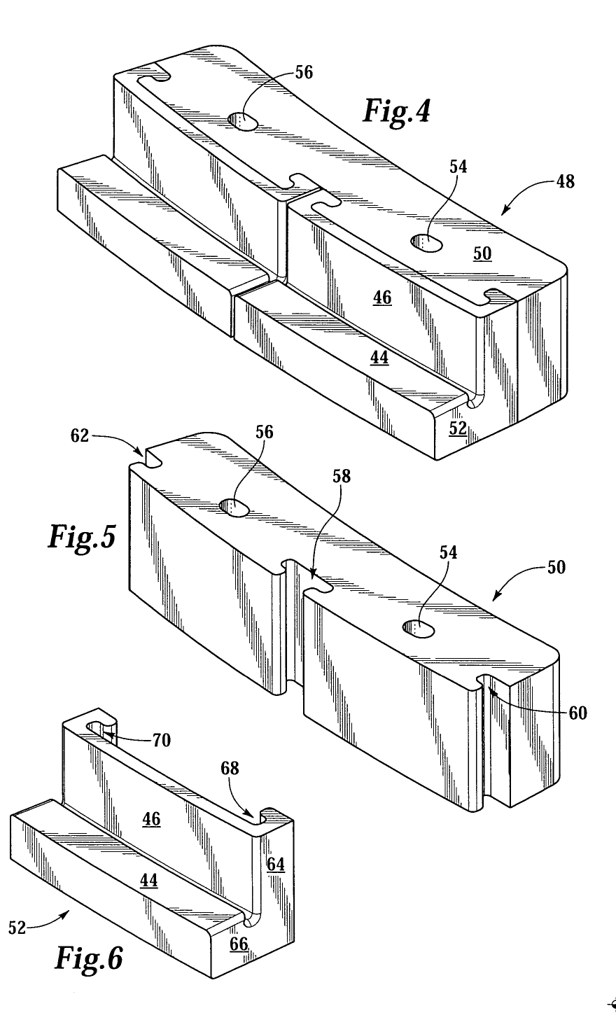

FIG. 5 illustrates a perspective view of the carrier block 50. Carrier block 50 comprises an intermediate dovetail channel 58 and first and second outer channels 60 and 62.

FIG. 6 illustrates a perspective view of the insert bearing 52. The bearing insert 52 comprises a side bearing 64 including the side wear surface 46 and a bottom bearing surface 66 including the bottom wear surface 44. The side bearing surface comprises first and second outer channels 68 and 70 that slidingly couple with the outer channel 60 and intermediate dovetail 58 of the carrier block 50. The bearing insert 52 has an initial wear-in time period in which there is lesser contact surface between the chain 42 and the wear surface 46 than after the wear-in time period. This additional contact surface slows down the rate of wear.

The lower wear surface 44 supports the weight of the towline chain, and the inner side rail wear surface 46 supports the chain tension that is necessary to operate the towline.

In the case of a corner section 40 bearing block, a second outer side rail wear surface (18 in FIG. 1) is not necessary in normal operation, since chain tension restrains the towline to a narrow band alongside the inner side rail 64. An outer rail may be present for safety to restrain the towline in case of a malfunction or other reasons. In a straight section of the track, however, there are preferably two side rails to hold the chain in place because there is not as much lateral force as compared to a corner section to prevent the chain from coming out of the track.

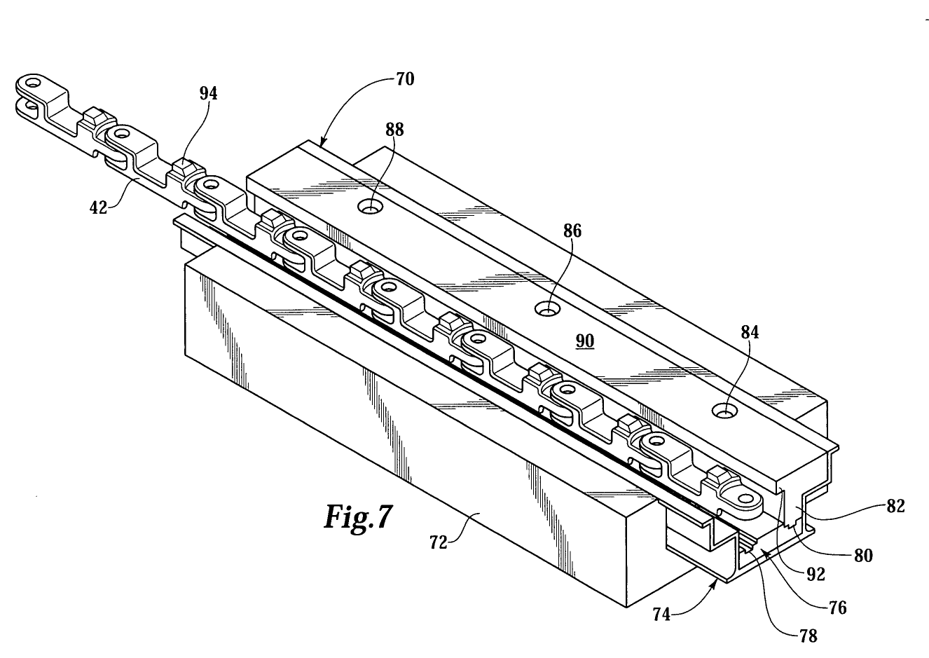

FIG. 7 illustrates a perspective view of a straight section 70 in a concrete floor 72. The straight section 70 comprises a welded steel mounting structure 74 cast into the concrete 72. A polymer-based composite bottom bearing 76 is positioned in the mounting structure 74 beneath the chain 42. Chain life is extended, as compared to a steel-chain on steel-wear surface design, because wear on the chain 42 is minimal with the polymer-based composite bottom bearing 76. Two longitudinal mating features are positioned on opposite sides of the chain 42 to interface with complementary mating features on side bearings.

The illustrated bottom bearing 76 comprises first and second channels 78 and 80 to receive a first side bearing (removed for viewing purposes) and second side bearings 82. The side bearing 82 is mounted to mounting structure 74 with bolts 84, 86 and 88. The side bearings 82 trap the bottom bearing 76 in the mounting structure eliminating the need for adhesives and fastening hardware to secure the bottom bearing 76 in the mounting structure 74. To further ease repair, the bottom bearing 76 and side bearings 82 are provided in sections that make replacement easy. A preferred section length for some application is between about two feet and six feet. The illustrated straight section is about three feet long and secured in place with three bolts per side.

In floor mounted applications, the side bearing 82 is preferably provided with a top 90 that is level with the floor 72. The top 90 comprises a flange 92 extending over a portion of the chain 42. Preferably, the flange 92 of the first side bearing 82 is positioned relative to the flange 92 of the second side bearing 82 such that the flanges overhang the chain 42 while allowing the chain dogs 94 to run between the flanges.

Another advantage of the towline system is that it does not need grease, and as a result, products of wear of the chain and track (swarf), e.g., contaminated dust, are not entrained in grease. A grease-free design approach makes it much easier to clean the track, as with a vacuum cleaner for example. The swarf accumulates in the two grooves beside the lower rail of the wear inserts, from which it is readily removed by vacuum and/or air blast.

Advantages of the invention include increased life expectancy of critical curved sections prior to repair or replacement; with no moving parts. There is no need to lubricate the track, resulting in decreased sensitivity to dirt contamination. The track is thus convenient to clean with vacuum/air blast, and there is no need to remove contaminated grease. Another benefit realized is reduced noise and vibration. Repair is easily and conveniently accomplished via replacement of only the worn surfaces. The invention can also provide consistent resistance to movement of the towline chain throughout the life of the track sections.

Non-Metallic Wearing Surfaces

Replacement of the guide rollers with non-moving guide members as described above meant that the driving chain moved against the guide members throughout the turns in the conveyor system. All of the force on the chain resulting from the movement of the heavy containers and the drive sprocket was directly applied to the non-metallic guide members. It was not certain that non-metallic materials could withstand such loads for long periods of time. However, the material formulated by the inventors has been found to exceed the typical life of the previous metal rollers by a factor of six or more.

The new conveyor system has many advantages over the previous design: The useful life of the curved sections of the conveyor has been much increased. The moving parts have been replaced by non-moving parts, which are easier to replace.
It is no longer necessary to lubricate the conveyor parts.
Since no grease is used, cleaning of the conveyor system is easier, and the environment is kept cleaner.
Noise and vibration are reduced when compared to the metal-to-metal contact of the previous design.
The resistance to the movement of the chain is more consistent.

The non-metallic parts in direct contact with the conveyor chain consist of a base polymer or polymers which provide a matrix for additives that improve the self-lubricating properties, improve resistance to abrasion, and extend life.

The base polymer may be either a thermoset or a thermoplastic polymer. Examples of thermoset polymers include, but are not limited to, polyurethanes, epoxies, reactive polyester/styrenes, and vinyl esters. Thermoplastic polymers that may be useful include, but are not limited to, polyamides, polyformaldehydes, polyolefins, polyesters, polyvinylidene fluorides, and benzoyl substituted poly (1,4-phenylene) (PARMAX®). It is to be understood that selection of the base polymer will depend on various factors, but particularly on the load that is to be placed on the wearing surface. In the conveyor system in which the invention has been demonstrated, the forces acting on the non-metallic surfaces are high, estimated to be in the range of 700 pounds per square inch at a maximum. Thus, the preferred base polymer is a polyether urethane prepolymer cured with 4,4′-methylene-bis-(2-chloroaniline) (MBCOA), which has been shown to perform best in the application.

In order to obtain the high resistance to wear and to provide self-lubrication, a group of additives was included in the base polymer. The selection of additives in other applications may be varied as the design requires. In one successful formulation, to the polyether urethane prepolymer and its curing agent were added aromatic polyaramide fibers (e.g. Kevlar®), spherical smooth surface ceramics (e.g. titanium carbide particles with an organic binder), fluorinated ultrahigh molecular weight polyethylene (F-UHMWPE), molybdenum disulfide, powdered polytetrafluoroethylene, and Fluoroguard® (a fluorinated polyether oil). The composition described in the examples below was found to successfully operate as replacements for the metal rollers in a heavy duty tow-line conveyor for 7 months without requiring replacement. On the basis of the performance and wear rate experienced there, the estimated life of the new non-metallic wearing blocks is estimated to be 2½ years, compared to about 4 months for the metal roller system that the non-metallic wearing blocks replaced.

Generally, non-metallic compositions of the invention may contain about 14 to 35 wt % of titanium carbide particles, about 5 to 9 wt % F-UHMWPE, about 0.5 to 5.5 wt % polyaramide fibers, about 7 to 11 wt % molybdenum disulfide, about 0 to 1.5 wt % fluorinated polyether oil, and about 1 to 5 wt % powdered polytetrafluoroethylene.

Particularly preferred non-metallic compositions of the invention will comprise about 60 wt % of an amine-cured polyether urethane prepolymer, about 12 wt % molybdenum disulfide, about 20 wt % micrometer-scale titanium carbide spheres, about 4 wt % fluorinated ultrahigh molecular weight polyethylene, about 2 wt % fluorinated polyether oil, about 1 wt % powdered polytetrafluoroethane, and about 1 wt % polyaramide fibers. The compositions may be varied to provide the necessary load-bearing capacity and abrasion resistance. Also, in any specific application the composition may be varied depending on the location of the load-bearing non-metallic surfaces.

The preferred matrix polymer is a polyether urethane prepolymer, which is cured by an amine curing agent, preferably 4,4′-methylene-bis-(2-chloroaniline) (MBCOA). Other curing agents might be substituted such as methylene-bis aniline (MBA). This matrix polymer is preferred since it has proven successful in a demanding application, but other polymers including but not limited to epoxies, reactive polyester/styrenes, and vinyl esters among the thermosets, and polyamides, polyformaldehydes, polyolefins, polyesters, polyvinylidene fluorides, and benzoyl substituted poly (1,4-phenylene) among the thermoplastics may be applicable, although not necessarily with equivalent results. Those skilled in the art will understand that the matrix will be selected based on the end use requirements, cost, physical properties, and other relevant considerations.

Molybdenum disulfide is a well known solid lubricant. It will normally be supplied as a powder and mixed with a reactive polymer component and other additives prior to curing of the mixture.

Titanium carbide particles have been used to provide abrasion resistance, low wear and self-lubrication properties in polymers. They have a smooth hard surface, in contradistinction to most metallic carbides, and are produced with an organic binder coating to promote bonding to the polymer matrix. Typically, they will have a nominal diameter of less than 1-2 μm.

Fluorinated ultrahigh molecular weight polyethylene (F-UHMWPE) has been used to provide improved abrasion resistance to other polymers. Fluorination sharply increases surface energy available to bond with the matrix polymer. F-UHMWPE is added as a powdered material to a reactive component of the polymer matrix and the other additives.

A small amount of a fluorinated polyether oil, known as an additive for polymers to improve mechanical properties, is also included in a preferred embodiment of the invention.

Polytetrafluoroethylene in powdered form is included for its chemical inertness and its low coefficient of friction.

Polyaramide fibers are added to stiffen and add shearing strength to the cured non-metallic wearing blocks.

In the examples below, the following components were combined to make the non-metallic wearing blocks of the invention:

| Component | Source |
|---|---|
| Polyether urethane prepolymer | Uniroyal Chemical Co. 2505 |
| Curing agent | Uniroyal Chemical Co. (MBCOA) |
| (4,4′-methylene-bis-(2-chloroaniline) | |
| Molybdenum disulfide | Climax, Inc. |
| Titanium carbide (1-2 μm) | Fluoro-Seal, Inc. |
| F-UHMWPE | Fluoro-Seal, Inc |
| Fluoroguard ®-PCA | DuPont |
| Teflon ® powder | DuPont |
| Fluorinated Kevlar ® fiber (12 μm) | DuPont |

The components will be included in amounts designated as parts by weight per hundred (pph), based on the matrix prepolymer.

### EXAMPLE 1

The polyether urethane prepolymer (100 parts) and 39 parts of the curing agent were mixed in a proportioning and mixing machine with 25 parts of molybdenum disulfide, 32 parts of titanium carbide particles, 20 parts of F-UHMWPE, and 1.5 parts of Fluoroguard®. Then, 5 parts of Teflon powder and 1 part of fluorinated Kevlar® fibers were added and mixed to form a stiff paste. The paste was placed in a mold and cured for 20 minutes at a temperature of 250° F. After the preliminary curing step, the part was removed from the mold and post-cured for 20 hours at 250° F.

### EXAMPLE 2

The non-metallic part made in Example 1 was tested for its physical properties, with the following results being obtained.

| | | |
|---|---|---|
| Hardness, Shore D | 85 | |
| Tensile strength, psi (MPa) | 9200 | (63) |
| Elongation at break, % | 40 | |
| Flexural modulus, psi (MPa) | 300,000 | (2060) |

### EXAMPLE 3

Non-metallic wearing blocks having the composition described in Example 1 were placed in service in a towline conveyor of the type described above for a period of 7 months, after which they were removed for physical inspection. This showed that after a break-in period when the blocks wore relatively rapidly until they developed a profile matching that of the chain and supported it fully, only about 24% of the thickness of the lubricated facing material had been worn away, so that the ultimate life of the surface could be estimated at about 2½ years before replacement would be necessary.

1. A towline conveyor comprising:
a generally fixed track;
a wearing surface in the track comprising a polymer-based composite; and
a chain positioned to run in the track along the wearing surface.

2. The towline conveyor of claim 1, wherein the composite wearing surface is formed from a plurality of wearing sections separably mountable in the track.

3. The towline conveyor of claim 2, wherein said wearing sections have uniform composition.

4. The towline conveyor of claim 2, wherein each of the plurality of wearing sections comprises a first section in contact with said chain and a second section supporting said first section.

5. The towline conveyor of claim 4, wherein said first section has a greater wear resistance than said second section.

6. The towline conveyor of claim 2, wherein the plurality of wearing sections comprise a plurality of generally flat surfaces contacting the chain.

7. The towline conveyor of claim 6, wherein the track comprises a corner section defining an inner radius and the generally flat surfaces contacting the chain in the corner section define bottom and side wear surfaces.

8. The towline conveyor of claim 7, wherein the bottom and side wear surfaces in the corner section are formed from a plurality of wearing inserts, each wearing insert comprising one of the bottom wear surfaces and one of the side wear surface.

9. A towline conveyor comprising:
a mounting structure;
a plurality of polymer-based bottom wearing sections replaceably mounted in the mounting structure; and
a chain running along the wearing sections.

10. The towline conveyor of claim 9, wherein the mounting structure is steel.

11. The towline conveyor of claim 9, wherein the mounting structure is mounted in a floor, and the bottom wearing sections are replaceable without breaking the floor or the mounting structure.

12. The towline conveyor of claim 9, a plurality of polymer-based side bearing sections replaceably mounted to the mounting structure.

13. The towline conveyor of claim 12, wherein the mounting structure is mounted in a floor and the top of the side wearing sections are level with the floor when the side wearing sections are mounted to the mounting structure.

14. The towline conveyor of claim 12, wherein the side bearing sections are mounted on opposite sides of the chain in one or more straight sections of the conveyor.

15. The towline conveyor of claim 9, comprising a plurality of wearing inserts defining the bottom wearing sections and defining corresponding side wearing sections, wherein the chain runs along the side bearing sections.

16. The towline conveyor of claim 15, comprising a plurality of carrier blocks mounted to the mounting structure, wherein the bearing inserts are replaceably mounted to the carrier blocks.

17. The towline conveyor of claim 16, wherein the carrier blocks and bearing inserts comprise mateable channels for replaceably mounting the bearing inserts to the carrier blocks.

18. A replaceable wearing surface for a towline conveyor comprising a mounting structure and a chain running relative to the mounting structure, wherein the replaceable wearing structure comprises:
a polymer-based wearing surface; and
structure adapted to removably connect the replaceable wearing surface to the mounting structure such that the chain runs along the polymer-based wearing surface.

19. The replaceable wearing of claim 18, wherein the mounting structure comprises a carrier block comprising channels for mating with the replaceable wearing surface and wherein the replaceable wearing surface comprises channels for mating with the carrier block.

20. The replaceable wearing surface of claim 19, wherein the mounting structure is mounted in a floor, and wherein top of the replaceable wearing surface is level with the floor when the replaceable wearing surface is mounted in the mounting structure.

21. A towline conveyor track comprising:
mounting structure, and
a plurality of wearing surfaces, wherein the wearing surfaces are substantially stationary relative to the mounting structure when said towline conveyor in operation.

22. The towline conveyor track of claim 21, wherein said wearing surfaces are replaceable.

23. A self-lubricating non-metallic composition comprising a mixture of
(a) at least one thermoplastic or thermoset polymer as a matrix;
(b) as additives
(1) titanium carbide particles
(2) F-UHMWPE
(3) polyaramide fibers and, optionally
(4) molybdenum disulfide,
(5) fluorinated polyether oil, or
(6) powdered polytetrafluoroethylene (PTFE)

24. A self-lubricating non-metallic composition of claim 23 wherein said matrix is a thermoplastic polymer.

25. A self-lubricating non-metallic composition of claim 24 wherein said thermoplastic polymer matrix comprises at least one member of the group consisiting of polyaramides, polyformaldehydes, polyolefins, polyesters, polyvinylidene fluorides, and benzoyl substituted poly (1,4-phenylene)

26. A self-lubricating non-metallic composition of claim 23 wherein said matrix is a thermoset polymer.

27. A self-lubricating non-metallic composition of claim 26 wherein said thermoset polymer matrix comprises at least one member of the group consisting of polyurethanes, epoxies, reactive polyester styrenes, and vinyl esters.

28. A self-lubricating non-metallic composition of claim 23 wherein said additives of (b) include molybdenum disulfide.

29. A self-lubricating non-metallic composition of claim 23 wherein said additives of (b) include a fluorinated polyether oil.

30. A self-lubricating non-metallic composition of claim 23 wherein said additives of (b) include powdered PTFE.

31. A self-lubricating non-metallic composition of claim 30 wherein the additives of (b) include each of additives (b)(1)-(b)(6).

32. A self-lubricating non-metallic composition comprising a cured mixture of
(a) at least one matrix polymer selected from the group consisting of amine-cured polyether urethane prepolymers, epoxies, and vinyl esters.
(b) as additives,
(1) molybdenum disulfide,
(2) titanium carbide particles,
(3) F-UHMWPE,
(4) fluorinated polyether oil,
(5) powdered PTFE,
(6) fluorinated polyaramide fibers.

33. A self-lubricating non-metallic composition of claim 32 comprising a matrix polymer 14 to 35 wt % of (b)(1), 5 to 9 wt % of (b)(2), 0.5 to 5.5 wt % of (b)(3), 7 to 11 wt % of (b)(4), 0 to 15 wt % of (b)(5), and 1 to 5 wt % of (b)(6).

34. A self-lubricating non-metallic composition of claim 32 wherein said matrix polymer is a polyether urethane prepolymer cured with MBCOA.

35. A self-lubricating non-metallic composition comprising a cured mixture of
(a) as a matrix an amine-cured polyether urethane prepolymer;
(b) as additives;
(1) molybdenum disulfide,
(2) titanium carbide particles,
(3) F-UHMWPE,
(4) fluorinated polyether oil,
(5) powdered PTFE,
(6) fluorinated polyaramide fibers.

36. A self-lubricating non-metallic composition of claim 35 containing 44.7 wt % polyether urethane prepolymer, 17.5 wt % amine curing agents, 11.2 wt % molybdenum disulfide, 14.3 wt % titanium carbide, 8.9 wt % F-UHMWPE, 0.67 wt % fluorinated polyether oil, 2.2 wt % powdered PTFE, and 0.45 wt % fluorinated polyaramide fibers.
